(19) United States
(12) Patent Application Publication
(10) Pub. No.: US 2017/0268722 A1
(43) Pub. Date: Sep. 21, 2017

(54) WHEEL BEARING GREASER

(71) Applicants: Todd Smith, Leon, WV (US); Lewis Holcomb, Leon, WV (US)

(72) Inventors: Todd Smith, Leon, WV (US); Lewis Holcomb, Leon, WV (US)

(21) Appl. No.: 15/425,661

(22) Filed: Feb. 6, 2017

Related U.S. Application Data
(60) Provisional application No. 62/310,077, filed on Mar. 18, 2016.

(51) Int. Cl. F16N 37/00; F16C 33/66

(52) U.S. Cl. CPC F16N 37/003; F16C 33/6622; F16N 2210/14; F16C 2326/02

(57) ABSTRACT

Implementations of a wheel bearing greater are provided. In some implementations, the wheel bearing greater may be connected to a pressurized grease source and used to pack grease into a bearing. In some implementations, the wheel bearing greater comprises a cylindrical portion configured to be inserted within an inner race of a bearing. In some implementations, the cylindrical portion comprises a solid cylinder having a channel extending around the outer surface of the cylindrical portion; a grease inlet port extending from an outer surface of a shoulder portion and through a portion of the cylindrical portion, and at least a first grease ejection port extending from the grease inlet port to the channel. The greater further comprises a shoulder portion secured to a first end of the cylindrical portion wherein the shoulder portion is larger in diameter than the cylindrical portion thereby creating a ledge around the cylindrical portion on the first end.

### CROSS REFERENCE TO RELATED APPLICATION

This application claims the benefit of U.S. Patent Application Ser. No. 62/310,077, which was filed on Mar. 18, 2016, and is incorporated herein by reference in its entirety.

### TECHNICAL FIELD

This disclosure relates to implementations of a wheel bearing greaser.

### BACKGROUND

Many wheels, such as those utilized on all-terrain vehicles (ATV's) and Utility Task Vehicle's (UTV's) including side by sides, for example, utilize wheel bearings to provide for smooth rotation of the wheels. Bearings often need to be greased in order to prevent wear and breakdown of the internal components such as the bearing balls and bearing races. Ungreased bearings will eventually malfunction which can cause damage to the vehicle if the malfunction occurs during use. Further, it can be difficult to apply grease to wheel bearings. The grease is prone to make a mess that can be difficult and time consuming to clean. Further, it is difficult to ensure complete grease coverage when applying grease to a bearing. Typically, bearings are discarded and new bearings purchased when bearings are in need to be greased.

### BRIEF DESCRIPTION OF THE DRAWINGS

FIGS. 1A and 1B illustrate an example wheel bearing greater according to an implementation of the present disclosure.

FIGS. 2A-2D illustrate an example cylindrical portion and shoulder portion of a wheel bearing greater according to an implementation of the present disclosure.

FIG. 3 illustrates an example method of using a wheel bearing greater according to an implementation of the present invention.

FIGS. 4A-4C illustrate an example cylindrical portion and shoulder portion of a wheel bearing greater according to another implementation of the present disclosure.

FIG. 5 illustrates another example wheel bearing greater according to an implementation of the present disclosure.

### DETAILED DESCRIPTION

Implementations of a wheel bearing greater are provided. In some implementations, the wheel bearing greater may be connected to a pressurized grease source and used to pack grease into a bearing. In this way, the service life of the bearing may be extended. Also, greasing a used bearing with the wheel bearing greater may push old grease and/or water therefrom and thereby extend its service life.

In some implementations, the wheel bearing greater comprises a cylindrical portion configured to be inserted within an inner race of a bearing. In some implementations, the cylindrical portion comprises a solid cylinder. In some implementations, the wheel bearing greater further comprises a shoulder portion secured to a first end of the cylindrical portion wherein the shoulder portion is larger in diameter than the cylindrical portion thereby creating a ledge around the cylindrical portion on the first end. In some implementations, the wheel bearing greater further comprises a grease inlet port extending from an outer surface of the shoulder portion and through a portion of the cylindrical portion, and at least a first grease ejection port extending from the grease inlet port to the outer surface of the cylindrical portion. In some implementations, the wheel bearing greater is configured to channel grease flowing out of the grease ejection port. In some implementations, the wheel bearing greater further comprises a channel extending around the outer surface of the cylindrical portion. In some implementations, the channel may be formed on the outer surface of the cylindrical portion by placing material around the outer surface of the cylindrical portion thereby forming a groove on the cylindrical portion. In some implementations, the channel may be formed by a groove formed in the cylindrical portion and extending around the outer surface of the cylindrical portion.

In some implementations, the cylindrical portion further comprises a threaded opening extending from a second end of the cylindrical portion and through a portion of the cylindrical portion. In this way, a washer may be operatively connected to the second end of the cylindrical portion. In some implementations, the wheel bearing greater further comprises a washer having an opening extending through the washer wherein the washer is larger in diameter than the cylindrical portion and a fastener having a threaded shaft configured to be received by the opening in the washer and the threaded opening in the cylindrical portion to attached the washer to the cylindrical portion.

In some implementations, the wheel bearing greater may not have the removable washer and/or fastener.

In some implementations, the grease ejection ports and channel may deliver grease to the bearing when a grease fitting is connected to the grease inlet port at the outer surface of the shoulder portion and a pressurized grease source to the grease fitting is connected to the grease fitting to inject grease into the greaser.

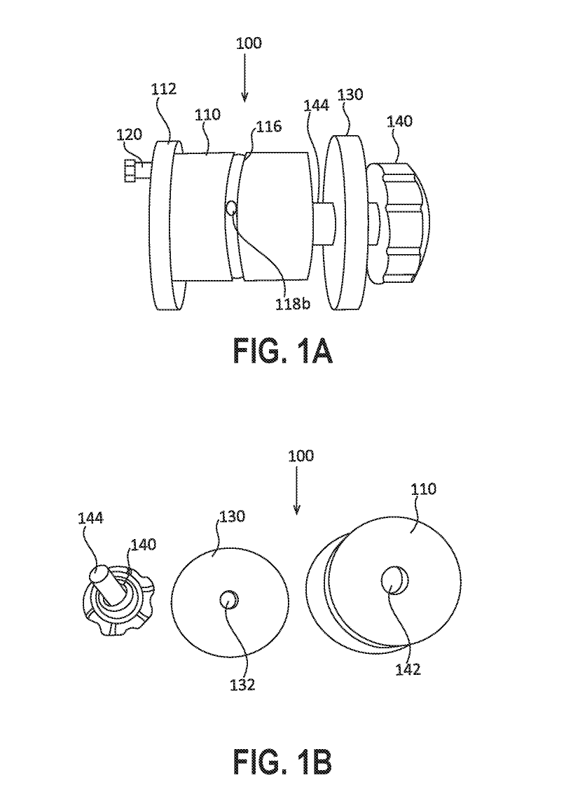

FIGS. 1A and 1B illustrate an example wheel bearing greater 100 according to an implementation of the present disclosure. FIG. 1A illustrates an example side view of the wheel bearing greater 100. FIG. 1B illustrates example component parts of the wheel bearing greater shown in FIG. 1A.

In some implementations, as discussed below, the wheel bearing greater 100 may be used to pack grease into a bearing.

As shown in FIGS. 1A and 1B, in some implementations, the wheel bearing greater 100 may comprise a cylindrical portion 110 and a shoulder portion 112 secured to a first end of the cylindrical portion 110.

In some implementations, the shoulder portion 112 may be a circular disk. In some implementations, the shoulder portion 112 may be wider than the cylindrical portion 110 thereby creating a ledge around the cylindrical portion 110 on the first end.

In some implementations, the wheel bearing greater 100 may comprise a washer 130 and an attachment device such as a wing nut 140 or other fastener that is removeably attached to the washer and a second end of the cylindrical portion 110.

A shown in FIG. 1B, in some implementations, the washer 130 may be a circular disk having an opening 132 that extends therethrough.

In some implementations, the cylindrical portion 110 may include a threaded opening 142 extending from the second end of the cylindrical portion 110 and through a portion of the cylindrical portion 110. In some implementations, the cylindrical portion 110 does not include a threaded opening 142 extending from the second end of the cylindrical portion 110 and through a portion of the cylindrical portion 110.

In some implementations, the opening 132 in the washer 130 may be configured to receive a threaded shaft 144 of the wing nut 140 or other fastener. The threaded opening 142 may be configured to receive and secure the threaded shaft 144 of the wing nut 140.

In some implementations, the washer 130 may be larger in diameter than the cylindrical portion 110. In this way, the wheel bearing greater 100 may include a shoulder or ledge on the second end of the cylindrical portion 110 when the washer 130 is operatively attached thereto.

In some implementations, the wheel bearing greater 100 may not include the removable washer 130 and/or the wing nut 140 or other fastener.

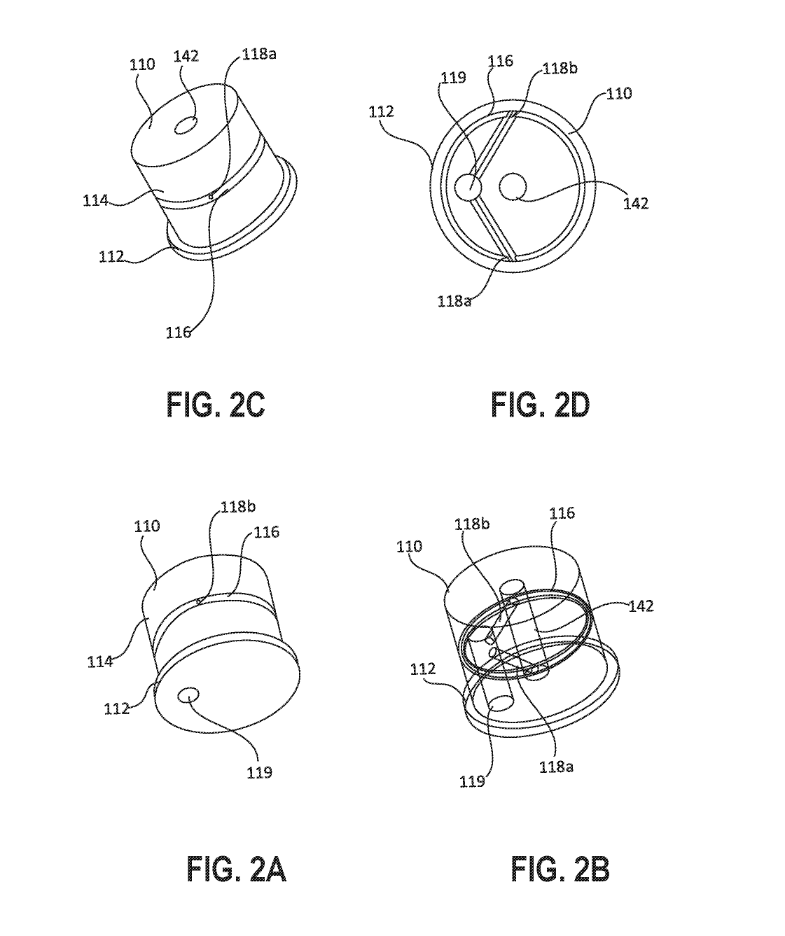

FIGS. 2A-2D illustrate an example cylindrical portion 110, channel, and shoulder portion 112 of the wheel bearing greater 100 when a grease inlet port 119 may be offset from the center of the cylindrical portion 110. FIG. 2A illustrates a first end of the wheel bearing greater 100 according to an implementation of the present disclosure. FIG. 2B illustrates a skeletonized view of FIG. 2A. FIG. 2C illustrates a second end wheel of the bearing greater 100 according to an implementation of the present disclosure. FIG. 2D illustrates a top, cross-sectional view of the wheel bearing greater 100.

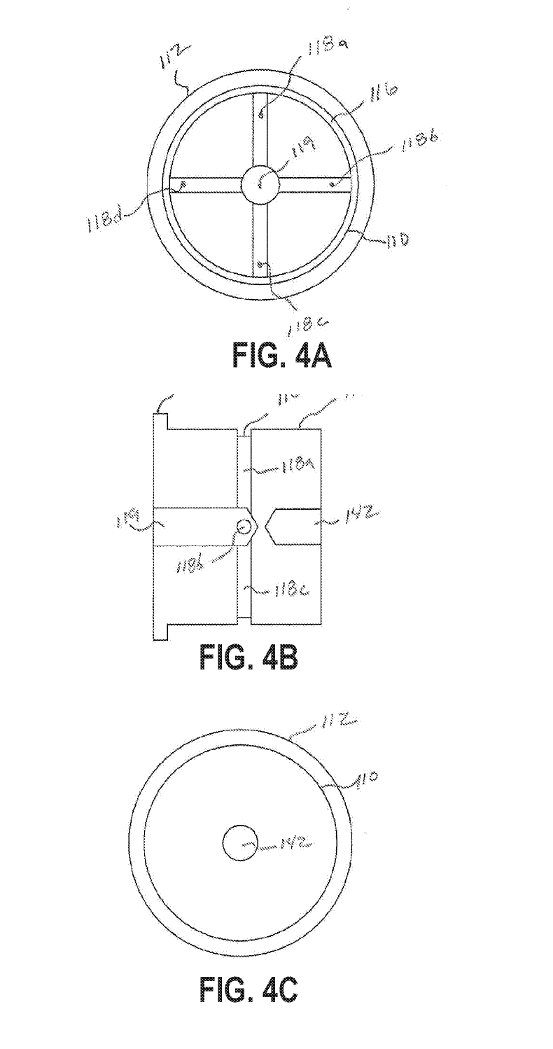

FIGS. 4A-4C illustrate another example cylindrical portion 110, channel, and shoulder portion 112 of the wheel bearing greater 100 when the grease inlet port may not be offset from the center of the cylindrical portion 110. FIG. 4A illustrates a cross-sectional view of a first end of an example implementation of the wheel bearing greater when the grease inlet port may not be offset from the center of the cylindrical portion 110. FIG. 4B illustrates a cross-sectional side view an example implementation of the wheel bearing greater when the grease inlet port may not be offset from the center of the cylindrical portion 110. FIG. 4C illustrates a cross-sectional view of a second end of an example implementation of the wheel bearing greater when the grease inlet port may not be offset from the center of the cylindrical portion 110.

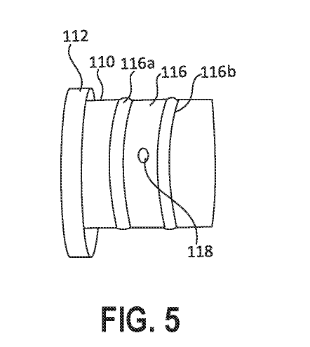

FIG. 5 illustrates another example wheel bearing greater according to an implementation of the present disclosure. FIG. 5 illustrate another example groove 116 when the channel is formed on the outer surface of the cylindrical portion by placing material (e.g., 116a, 116b) around the outer surface of the cylindrical portion thereby from a groove 116 on the cylindrical portion.

As shown in FIGS. 2A-2D and/or FIGS. 4A-4C, in some implementations, the cylindrical portion 110 may comprise a solid cylinder having a channel in the form of a circumferential groove 116 formed in the cylindrical portion 110 and extending around its outer surface, a grease inlet port 119 extending through a portion of the cylindrical portion 110, two or more grease ejection ports 118a, 118b, 118c, 118d (collectively grease ejection ports 118) extending through a portion of the cylindrical portion 110, and a threaded opening 142 extending through a portion of the cylindrical portion 110. In some implementations, the cylindrical portion 110 does not include the threaded opening 142.

In some implementations, the cylindrical portion 110 may be configured to be inserted into the inner race of a bearing as discussed below. In this way, the grease ejection ports and channel may deliver grease to the bearing 180. As discussed above, in some implementations, the channel may be formed as a circumferential groove 116 formed in the cylindrical portion 110 and extending around its outer surface or the channel may be formed on top of the outer surface of cylindrical portion 110 with channel forming material extending around the outer surface of the cylindrical portion 110 (FIG. 5). In either implementation, the wheel bearing greater comprises a groove around the cylindrical portion 110.

As shown in FIGS. 2A-2D and FIGS. 4A-4C, in some implementations, the shoulder portion 112 may be positioned on the first end of the cylindrical portion 110. In some implementations, the shoulder portion 112 may be larger in diameter than the cylindrical portion 110. In this way, the shoulder portion 112 may serve as a stop and help position the cylindrical portion 110 of the wheel bearing greater 100 within the inner race of a bearing during use.

As shown in FIG. 2B and FIG. 4B, in some implementation, the grease inlet port 119 may be an elongated opening that extends from the outer surface of the shoulder portion 112 into the cylindrical portion 110 and may be in fluid communication with the grease ejection ports 118.

As shown in FIG. 2D, in some implementations, the grease inlet port 119 may be offset from the center of the cylindrical portion 112. However, as shown in FIGS. 4A-C, the grease inlet port 119 may be not be offset from the center of the cylindrical portion 112.

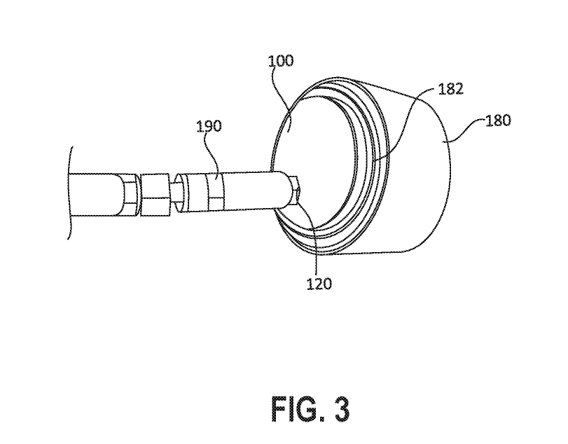

As shown in FIG. 1A, in some implementations, the grease inlet port 119 is configured to receive and retain therein a grease fitting 120 at the outer surface of the shoulder portion 112. In some implementations, the grease fitting 120 is configured to interface with a pressurized grease source 190 (FIG. 3) such as a grease gun or other pressurized grease source.

In some implementations, the grease inlet port 119 may be located in the center of the shoulder portion 112. In some implementations, the grease inlet port 119 may be located in the center of the shoulder portion 112 when the threaded opening 142 is not present. As shown in FIGS. 4A-C, in some implementations, the grease inlet port 119 may be located in the center of the shoulder portion 112 when the threaded opening 142 is present.

In some implementations, the grease inlet port 119 may be a cylindrical shape or any suitable shape for allowing grease to pass therethrough into the grease ejection ports 118.

As shown in FIGS. 2B and 2D and FIGS. 4A and 4B, in some implementations, each of the grease ejections ports 118 may be elongated openings in the cylindrical portion 110 that extend from the grease inlet port 119 to the channel in the form of a circumferential groove 116. As shown in FIG. 5, in some implementations, each of the grease ejections ports 118 may be elongated openings in the cylindrical portion 110 that extend from the grease inlet port 119 to a channel formed on top of the outer surface of cylindrical portion 110 with channel forming material extending around the outer surface of the cylindrical portion 110. In either implementation, each of the grease ejections ports 118 may be elongated openings in the cylindrical portion 110 that extend from the grease inlet port 119 to a groove around the cylindrical portion 110.

As shown in FIGS. 2B and 2D and FIG. 4A, in some implementations, each of the grease ejection port 118 extend from the grease inlet port 119 to the channel in a direction different than the direction that the other grease ejection ports extend from the grease inlet port 119 to the channel.

As shown in FIGS. 2B and 2D and FIG. 4A, in some implementations, a first end of each grease ejection port 118 are in fluid communications with the grease inlet port 119. As shown in FIGS. 2B and 2D and FIG. 4A, in some implementations, a second end of each grease ejection port 118 are disposed within the channel.

As shown in FIGS. 2A and 2D, in some implementations, the grease ejection ports 118 extend from the grease inlet port 119 at an angle to, in some implementations, bypass the threaded opening 142 and/or to position the second ends of the ejection ports 118 on opposite sides of the cylindrical portion 112, respectively. Similarly, as shown in FIGS. 4A and 4B, when the grease inlet port 119 extends down a portion of the center of the cylindrical portion 112, in some implementations, the grease ejection ports 118 extend from the grease inlet port 119 to position the second ends of a pair of grease ejection ports (e.g., 118a and 118c; 118b and 118d) on opposite sides of the cylindrical portion 112, respectively.

In some implementations, the grease ejection ports 118 may be a cylindrical shape or any suitable shape for allowing grease to pass therethrough from the grease inlet port and into the circumferential groove 116.

In some implementations, there may be two grease ejection ports 118 as shown in FIG. 2D, more than two grease ejection ports 118 as shown in FIG. 4A, or less than two grease ejection ports 118.

FIG. 3 illustrates an example method of using a wheel bearing greater according to an implementation of the present invention.

To use the wheel bearing greater 100, in some implementations, the washer 130 may first be removed from the cylindrical portion 110.

Then, in some implementations, the cylindrical portion 110 of the wheel bearing greater 100 may be inserted into the inner race 182 of a bearing 180. In some implementations, the shoulder portion 112 of the cylindrical portion 110 may come to rest against a portion of the bearing 180.

Next, in some implementations, the washer 130 may be operatively attached to the second end of the cylindrical portion 110. In some implementations, the washer 130 may be operatively attached to the second end of the cylindrical portion 110 by inserting the threaded shaft 144 of the wing nut 140 or other fastener through the opening 132 in the washer 130 and then inserting the treaded shaft 144 into the threaded opening 142 of the cylindrical portion 110. In this way, the cylindrical portion 110 may be secured within the inner race 182 of a bearing 180.

Next, in some implementations, a pressurized grease source 190 may be connected to the grease fitting 120. Grease from the pressurized grease source 190 may cause grease to be injected into the grease inlet port 119, which may travel through the grease ejection ports 118 and into the channel of the wheel bearing greater and bearing 180. Also, in some implementations, the grease may be spread around by rotating the bearing 180 about the cylindrical portion 110.

To remove the wheel bearing greater 100 from the bearing 180, in some implementations, the wing nut 140 and then the washer 130 are removed from the cylindrical portion 110. Then, in some implementations, the cylindrical portion 110 is removed from the inner race 182 of the bearing 180.

In implementations of the wheel bearing greater 100 that do not include the removable washer 110 and/or wing nut 140 or other fastener, the steps associated with the attachment and/or removal of the washer 110 are omitted.

In some implementations, the cylindrical portion 110, shoulder portion 112 and/or the washer 130 may be manufactured of aluminum or an aluminum alloy. In some implementations, the cylindrical portion 110, shoulder portion 112, and/or the washer 130 may be manufactured from any material (e.g., steel, titanium, etc.) suitable for use as part of a wheel bearing greater 100.

Reference throughout this specification to “an embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations are depicted in the drawings in a particular order, this should not be understood as requiring that such operations be performed in the particular order shown or in sequential order, or that all illustrated operations be performed, to achieve desirable results.

1. A wheel bearing greater comprising:
a cylindrical portion configured to be inserted within an inner race of a bearing wherein the cylindrical portion comprises a solid cylinder having a channel extending around the outer surface of the cylindrical portion; a grease inlet port extending from an outer surface of a shoulder portion and through a portion of the cylindrical portion, and at least a first grease ejection port extending from the grease inlet port to the channel; and
a shoulder portion secured to a first end of the cylindrical portion wherein the shoulder portion is larger in diameter than the cylindrical portion thereby creating a ledge around the cylindrical portion on the first end.

2. The wheel bearing greater of claim 1 further comprising a second grease ejection port extending from the grease inlet port to the channel.

3. The wheel bearing greater of claim 2, wherein the first grease ejection port extends from the grease inlet port in a first direction and the second grease ejection port extends from the grease inlet port in a second direction.

4. The wheel bearing greater of claim 1, wherein the grease inlet port is offset from the center of the cylindrical portion.

5. The wheel bearing greater of claim 4 wherein the cylindrical portion further comprises a threaded opening extending from a second end of the cylindrical portion and through a portion of the cylindrical portion, the wheel bearing greater further comprising a washer having an opening extending through the washer wherein the washer is larger in diameter than the cylindrical portion and a fastener having a threaded shaft configured to be received by the opening in the washer and the threaded opening in the cylindrical portion.

6. A wheel bearing greater comprising:
a cylindrical portion configured to be inserted within an inner race of a bearing wherein the cylindrical portion comprises a solid cylinder a grease inlet port extending from an outer surface of a shoulder portion and through a portion of the cylindrical portion and at least a first grease ejection port extending from the grease inlet port to the outer surface of the cylindrical portion; and
a shoulder portion secured to a first end of the cylindrical portion wherein the shoulder portion is larger in diameter than the cylindrical portion thereby creating a ledge around the cylindrical portion on the first end.

7. The wheel bearing greater of claim 6 further comprising a channel extending around the outer surface of the cylindrical portion wherein the first grease ejection port extend from the grease inlet port to the channel.

8. A method of greasing a bearing using the wheel bearing greater of claim 1, the wheel bearing greater further comprising a grease fitting connected to the grease inlet port at the outer surface of the shoulder portion, the method comprising:
inserting the cylindrical portion of the wheel bearing greater into an inner race of a bearing;
connecting a pressurized grease source to the grease fitting; and
injecting grease using the pressurized grease source into the grease inlet port, through the first grease ejection port, and into the channel and the bearing.

9. The method of claim 8 wherein the wheel bearing greater further comprises a second grease ejection port extending from the grease inlet port to the channel, the method further comprising injecting grease using the pressurized grease source into the grease inlet port, through the first and second grease ejection port, and into the channel and the bearing.
